(19) United States
(12) Patent Application Publication
(10) Pub. No.: US 2009/0196849 A1
(43) Pub. Date: Aug. 6, 2009

(54) Fishing Lure Formulations

(75) Inventor: Donald W. KELLEY, Athens, TX (US)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Pure Fishing, Inc., Spirit Lake, IA (US)

(21) Appl. No.: 12/369,146

(22) Filed: Feb. 11, 2009

Related U.S. Application Data
(62) Division of application No. 11/041,139, filed on Jan. 20, 2005.

(51) Int. Cl. A01N 25/10

(52) U.S. Cl. 424/84

(57) ABSTRACT

The invention is directed to compositions comprising at least one water-soluble long-chain polyhydroxy polymer for making soft, biodegradable, artificial fishing lures that may readily be removed from a mold in their frozen state, to methods for making such fishing lures, and to the resultant fishing lures.

“This is a division of application Ser. No. 11/041,139 filed Jan. 20, 2005, now pending.”

### FIELD OF THE INVENTION

The present invention relates to polymeric biodegradable fish lures, compositions therefor, and processes for manufacturing the compositions and the lures.

### BACKGROUND OF THE INVENTION

Several compositions are known to be recommended for artificial fish lures. The preferred composition and the standard for the recreation fishing industry are the polyvinyl chloride plastisols (PVC). PVC is ideally suited for formulating and molding soft lures. However, PVC has two major drawbacks: i) it does not biodegrade in the environment, nor is it digestible, and ii) it does not release fish attractants efficiently.

PVC is persistent in the environment and is not digestible by fish or animals. Fish are known to have completely blocked their digestive systems by consuming PVC lures, resulting in the death of the fish. PVC plastisol lures are comprised of polyvinyl chloride, hydrocarbon plasticizers, oil extenders and stabilizers. These compounds are not water-soluble and will persist in the lakes and rivers year after year. It is obvious that a biodegradable lure would be advantageous to the environment as well as to the fish that take the lure but are not caught or those that find and eat the lost lures.

PVC lures do not release active chemicals (attractants) very well, and generally from the surface of the lure only. Active chemicals present inside of a PVC lure are not released at all or at best are released at a very slow and ineffective rate from fish lures. Clearly a more efficient release of chemical attractants would be desirable.

Compositions have been described that could meet the biodegradable and release of attractant issues, but they do not address the necessary properties required of a soft recreational fishing lure. Additionally, they have disadvantages even within the technologies described.

U.S. Pat. No. 6,174,525 (Kelley) describes a biodegradable fishing lure and a method of manufacture. While lures manufactured within the teaching of this patent have all of the necessary properties desired in a lure, it has now been discovered that, during large-scale production, the manufacturing process has certain drawbacks. In this patent, the lure compound is required to be injected into a mold, shaped and frozen, in order to set the polyvinyl alcohol to a solid state. However, in mass production utilizing continuously cold molds, a problem with this procedure is that, when injected into a mold and frozen, the water in the formulation expands and locks itself into the mold. To remove the lure from the mold requires heating the mold, which means the mold has to go through at least one freeze-thaw cycle. Ejector pins do not work because the lure is brittle when frozen and it breaks when forced out of the mold in its frozen state.

Additionally, lures prepared according to U.S. Pat. No. 6,174,525 require a significant amount of time for the polyvinyl alcohol to come to equilibrium (hardness) with respect to any crosslinking or crystallization. As these two functions increase, they cause increasing hardness of the lure. If the lure is the correct hardness when removed from the mold, it can over time become too hard.

### SUMMARY OF THE INVENTION

The present invention is directed to molded fish lures, compositions therefor, and processes for manufacturing the lure and the compositions, wherein the lure exhibits improved demolding properties. That is, it may be frozen to set its shape and may be readily removed from a mold while still frozen. The fish lures of the invention maintain the desirable properties of the prior art lures, that is, they are soft and they exhibit superior durability, tensile strength, flexibility, elasticity, cohesive strength, aesthetic appeal, and low cost. Importantly, they are biodegradable and can release fish attractants efficiently. The artificial lures of the invention may take the form and shape of, for example, worms, night crawlers, grubs, shad, crawfish, salmon eggs, mealworms, and the like. By “soft” is meant that the lure has a Shore OO durometer reading of from about 0 to about 50 on an ASTM D2240 OO type scale. Fish lures having a Shore durometer reading within this range also exhibit many of the other necessary requirements of an acceptable lure, including flexibility, elasticity, and aesthetic appeal (as it relates to feel).

Compositions for making soft, water-soluble, artificial fishing lures that may readily be removed from a mold in their frozen state, comprise a water-soluble, biodegradable long-chain polymer. The compositions comprise, in one embodiment, the water-soluble, biodegradable long-chain polymer. The compositions comprise, in one embodiment, the water-soluble, biodegradable long-chain polyhydroxy polymer and magnesium chloride. In a second embodiment, the compositions comprise the water-soluble biodegradable long-chain polyhydroxy polymer, dimethyl alkyl tertiary amine and dialkyl dimethyl quaternary amine. The MgCl salt and the amines may be used separately or they may be used in combination with each other. The compositions may optionally further include an aromatic hydroxyl compound, which may act as a hydrogen-bonding accelerator. The compositions of the invention may additionally and optionally include other additives such as, for example, plasticizers, fish attractants, water, preservatives, coloring agents and glitter, and the like.

The present invention is further directed to a process for the manufacture of a fish lure, the process comprising obtaining an aqueous solution of a biodegradable long-chain polyhydroxy polymer and either a) magnesium chloride, or b) dimethyl alkyl tertiary amine and dialkyl dimethyl quaternary amine, or c) MgCl and the aforementioned amines; optionally adding to the solution a hydrogen-bonding accelerator to form a mixture; heating and stirring the mixture until all of the ingredients are admixed and the long-chained polymer is dissolved; shaping the mixture into the form of a fish lure; subjecting the formed fish lure to freezing temperatures; and removing the fish lure while still frozen.

### DETAILED DESCRIPTION OF THE INVENTION

The term “long-chain polyhydroxy polymer”, as used herein and in the appended claims, refers to network and linear polyhydroxy polymers with a molecular weight of not less than 50,000 and a degree of polymerization (DP) about 1600. In the practice of the present invention, the biodegradable long-chain polymer of the fishing lure composition may be selected from, for example, amorphophallus konjac, polyvinyl alcohol (PVA), and the like. The amount of long-chain polymer will generally be from about 1 wt % to about 24 wt % of the total composition. The preferred long-chain polymer is PVA, and a preferred PVA has the following structure, where x is from about 500 to about 3000.

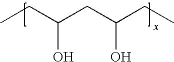

The PVA will preferably be at least about 89%, more preferably about 99% hydrolyzed, with a DP of 1,600 to 2,800.

Konjac may be used in combination with PVA and when so used, the konjac is present in an amount of from 0.1 wt % to 4.0 wt % of the composition. Preferably, the amorphophallus konjac consists of mannose and glucose in a molar ratio of 1.6:1, respectively, with beta 1-4 linkage.

It has been previously found that in using the above polymers, while many of the desired characteristics of an acceptable fishing lure were achieved, the compositions were found to be lacking in cohesive strength when the lures are large or heavy. While small or lightweight lures were acceptable, large/heavy lures molded from the above polymers, alone or in admixture with biodegradable polymeric gums, would not stay on a hook, would slip down or off the hook, or would fracture and break after several hard casts while being fished.

These shortcomings in large or heavy fish lures are overcome by subjecting the lures after molding to freezing temperatures for various time intervals. This freezing step results in lures having sufficient cohesive strength to remain on a hook, even after many casts. Without being bound by theory, it is believed that this increase in cohesive strength is due to hydrogen bonding catalyzed by freezing.

The freezing temperatures (at 35° F. or 0° C., and below) cause hydrogen bonding to take place. After hydrogen bonding has taken place in accordance with the present invention, the lures increase their cohesive strength and retain other physical properties up to temperatures of about 150° F. However, above this temperature, the lures begin to soften and become very soft and then change to a liquid at temperatures of about 180-190° F. The hydrogels of the invention are heat- and cold-reversible, so that the hydrogen bonding can be reinitiated by refreezing the lure.

It was found in testing for shelf life of the lures that successive freeze/thaw cycles create lures that continue to get harder and stiffer. This hardness-stiffness eventually draws the molecules so tight that syneresis of liquids occurs and the fish lure becomes unacceptable; that is, increased hydrogen bonding initiates severe syneresis (weeping), which changes the physical properties of the lures unacceptably.

While the addition of a biodegradable polymeric gum to the long-chain polymers impedes the hardening (curing) process of the fish lures after two to five freeze/thaw cycles, hardening continues and some syneresis gradually takes place. Because these prior art lures cannot be readily removed from a mold when frozen, they must be thawed. Additionally, the lures required a significant amount of time for the PVA to come to a hardness equilibrium. If it was the correct hardness when removed from the mold, it often would over time become too hard for use as a lure.

According to the present invention, it has now been discovered that magnesium chloride can be added to the long-chain polymer to prevent the lure from locking itself into the mold cavity at the temperatures required for the formulation to set. This allows the lure to be frozen to set its shape and to be readily removed from the cold mold without breaking. It has also been found that the use of magnesium chloride allows for the use of higher levels of the long chain polymer, which in turn allows for the use of lower molecular weights of the long chain polymer to obtain sufficient cohesive forces and tensile strengths for an acceptable lure. Thus, the long-chain polymer's molecular weight may be as low as 50,000 with a degree of polymerization of 1600. The addition of MgCl to the formulation has the added advantage of reducing the total amount of water necessary in the formulation. This reduces the loss of the remaining water to evaporation within a package and completely eliminates all syneresis. This in turn eliminates the need to include a polymeric gum in the formulation. When included in the formulation, the amount of MgCl will generally be from about 15 wt % to about 40 wt % of the total composition.

Additionally, it has been found that the use of two amines, dimethyl alkyl tertiary amine and dialkyl dimethyl quaternary amine, will also show or stop the increasing hardness of the lure over time. The inclusion of these amines shortens the time for the long-chain polymer to reach equilibrium and reduces the final hardness the lure will reach. It allows for higher levels of long-chain polymer to be used, which additionally gives better demolding properties as well as allowing the use of lower molecular weights of the long-chain polymer. The carbon range of the “alkyl” component of the amines is C12 to C18. The amines are commercially available; for example, they may be obtained from Akzo Chemie America under the trade names Armeen DMSD (dimethyl alkyl tertiary amine) and Arquad 2HT-75 (dialkyl dimethyl quaternary amine). When included in the formulation, the amount of dimethyl alkyl tertiary amine is from about 0.1 wt % to about 1.0 wt % of the total composition and the amount of dialkyl dimethyl quaternary amine is from about 0.1 wt % to about 1.0 wt % of the total composition.

The use of an aromatic hydroxyl compound as an accelerator allows the curing process (hydrogen bonding) to be accelerated when the lures are subjected to freezing temperatures. The cure time can be reduced to less than one minute. This is especially useful when higher amounts of the long-chain polymer are used. This allows for adjustments on the amounts of polymers to provide complete cures while retaining the other desirable physical properties, to give an acceptable fish lure. Examples of accelerators useful in the present invention include, but are not limited to, catechol, nordihydroguaiaretic acid, hydroquinone, anthraquinon, resorcinol, gallic acid, pyrogallol, phloroglucinol, propyl gallate, glutaric acid, and the like. The accelerator, when present in the formulation, is generally in the amount of from about 0.1 wt % to about 2.0 wt % of the total composition.

A particularly desirable characteristic of the fish lures of the present invention is their ability to release affractants efficiently and effectively into the water environment. Thus, attractants may optionally be, and preferably are included in the fishing lure composition of the invention. Chemicals that will attract fish are well known in the art and include, but are not limited to, Berkley's fish attractants; garlic oil; menhaden products, such as menhaden fish solubles, menhaden hydrolyzed fish solubles and menhaden oil; and the like. When included in the composition, the attractants are generally present in an amount of from about 1 wt % to about 30 wt %, preferably from about 5 wt % to 25 wt % of the total composition.

Plasticizers may be added to the polymeric composition of the invention to facilitate processing and to increase the flexibility and toughness of the final fishing lure. Plasticizers and their use are well known in the art and may be chosen without undue experimentation. Plasticizers that may be used include, but are not limited to, sorbitol, glycerin, propylene glycol, n-methylpyrrolidone, and the like. They are present in the composition in an amount of from 0 wt % to about 20 wt %, preferably from about 1 wt % to about 10 wt %.

Water is generally present in the composition of the invention in an amount of more than 25 wt % of the total composition, more generally in the range of from about 25 wt % to about 60 wt %.

In preparing the fishing lures of the invention, the long-chain polymer and any additional components of the composition are stirred at high temperature (usually approximately 190-205° F.) until the polymer is in complete solution. When the polymer is completely dissolved, the temperature of the mixture may either be maintained or cooled somewhat while the mixture is injected into cold molds (generally cooled to from about 32° to about −30° F.). The polymer mixture is held in the cold molds for a short period of time to allow the composition to solidify and cure, after which the resulting frozen lures are readily ejected or otherwise removed from the cold molds. Be “readily removed” is meant that, at freezing temperatures, the lure will not stick to or otherwise lock itself into the mold, nor will it break as it is removed from the mold. The resulting molded lure will be soft and will retain its shape at room temperature. Alternatively, after dissolution, the mixture may be cooled and stored at room temperature, and at a later time is then reheated and injected into cold molds.

The following examples illustrate the practice of the present invention. Parts are given as percentages and temperature is in degrees Fahrenheit unless otherwise noted. “RT” is room temperature.

### EXAMPLES

### Example 1

A composition of the following formulation was prepared:

| Component | Amount (wt %) |
|---|---|
| Distilled Water | 36.09 |
| Polyvinyl alcohol (DuPont PVA 90-50) | 12.00 |
| Magnesium chloride | 25.00 |
| Fish attractant | 15.00 |
| Glycerin | 10.00 |
| Gallic Acid | 0.56 |
| Citric Acid | 0.20 |
| Armeen DMSD | 0.50 |
| Arquad 2HT-75 | 0.75 |

DuPont PVA 90-50 (DuPont Inc.) has a MW of 90,000, a degree of polymerization of 1600, and 99.0-99.8% hydrolysis.

Manufacturing procedure: All ingredients are added to the mixing vessel. The mixture is heated to 205° F. and mixed until the PVA is in complete solution. The mixture is then cooled to 150°, after which it is shot into cold (−10°) molds. The mold is held at that temperature for a short period of time (of from about 10 seconds to about 2 minutes), after which it is opened and the molded lure is removed from the cold mold and packaged.

Fish lures made by this example will retain their shape at room temperature, and also their cohesive strength after repeated hard casting. Additionally, they remain soft and do not become too hard or brittle over time. Their equilibrium shore OO durometer will be 25+/−.

### Example 2

The following compositions were prepared:

| | Amount (wt %) | |
|---|---|---|
| Component | Formula A | Formula B |
| Polyvinyl alcohol (Celanese Celvol 165SF) | 10.0 | 10.0 |
| Water | 38.8 | 29.6 |
| Magnesium Chloride | 25.0 | 35.0 |
| Glycerin | 15.0 | 15.0 |
| Attractant | 10.0 | 10.0 |
| Gallic Acid | 1.0 | 0.5 |
| NaEDTA | 0.2 | 0.2 |

Celvol 165SF (Celanese Chemical Co.) has a MW of 203,500, a degree of polymerization of 2770, and 99.8+% hydrolysis.

The same mixing and molding procedure as in Example 1 is used. These formulations are frozen and easily demolded after one minute at −10 F. Fish lures made from either of Formulation A or B will retain their shape at room temperature and also their cohesive strength after repeated hard casting. Additionally, they remain soft and do not become too hard or brittle over time. Lures molded from Formulation A will exhibit a shore OO durometer of 45.0+/− when equilibrium is reached. Lures molded from Formulation B will exhibit a shore OO durometer of 35.0+/− equilibrium is reached. Lures molded from Formulation B will exhibit a shore OO durometer of 35.0+/− when equilibrium is reached.

### Example Three

A composition of the following formulation was prepared:

| Component | Amount (wt %) |
|---|---|
| polyvinyl alcohol (Celanese Celvol 540S) | 4.0 |
| polyvinyl alcohol (Celanese Celvol 165SF) | 6.0 |
| Water | 39.0 |
| Magnesium Chloride | 20.0 |
| Glycerin | 20.0 |
| Attractant | 10.0 |
| Arquar 2HT-75 | 0.5 |
| Armeen DMSD | 0.5 |

Celvol 540S (Celanese Chemical Co.) has a MW of 150,000+, a degree of polymerization of 2000+, and 89.0% hydrolysis.

The same mixing and molding procedure as in Example 1 is used. Fish lures made by this example will retain their shape at room temperature and also their cohesive strength. Additionally, they remain soft and do not become too hard or brittle over time. This formulation is frozen and is easily demolded after one/two minutes at −10° F.

What is claimed is:

1. A process for manufacturing a fish lure, the process comprising:
obtaining an aqueous solution of a) at lease one water-soluble long-chain polyhydroxy polymer and b) a second component comprising i) magnesium chloride or ii) dimethyl alkyl tertiary amine and dialkyl dimethyl quaternary amine or iii) MgCl and the aforementioned amines;
optionally adding to the solution a hydrogen-bonding accelerating aromantic hydroxyl compound;
heating and stirring the mixture until all of the ingredients are admixed and the long-chain polymer is dissolved;
shaping the mixture into the form of a fish lure in a mold;
subjecting the formed fish lure to freezing temperatures; and removing the fish lure from the mold while still frozen; to give a fish lure that is biodegradable, can release fish attractant and has a Shore 00 durometer reading of from 0 to about 50.

2. A process according to claim 1 which comprises the further step of adding a fish attractant to the solution.

3. A process according to claim 1 wherein the second component is magnesium chloride.

4. A process according to claim 1 wherein the second component comprises magnesium chloride, dimethyl C₁₂₋₁₈alkyl tertiary amine, and di-C₁₂₋₁₈alkyl dimethyl quaternary amine.

5. A process according to claim 1 wherein the at lease one water-soluble polyhydroxy polymer is polyvinyl alcohol and, optionally, amorphophallus konjac.
